(19) United States
(12) Patent Application Publication
(10) Pub. No.: US 2007/0078698 A1
(43) Pub. Date: Apr. 5, 2007

(54) SUPPLY AND DEMAND PLANNING BY OMITTING ORDER ITEM

(75) Inventors: Orna R. Anker, Stamford, CT (US); Anthony V. Ferreri, Hyde Park, NY (US); Lawrence R. Fox, Poughkeepsie, NY (US); Glenn E. Pedersen, Montgomery, NY (US)

Correspondence Address: HOFFMAN, WARNICK & D'ALESSANDRO LLC, 75 STATE ST, 14TH FL, ALBANY, NY, 12207, US

(73) Assignee: INTERNATIONAL BUSINESS MACHINES CORPORATION, Armonk, NY (US)

(21) Appl. No.: 11/163,100

(22) Filed: Oct. 5, 2005

(51) Int. Cl. G06F 17/30

(52) U.S. Cl. 705/10

(57) ABSTRACT

Method, system and program product for providing supply and demand planning by omitting an atypical order item is disclosed. In one embodiment, the invention includes a method of identifying an atypical order item, and omitting the atypical order item from at least one of the following: a forecast demand and an order item demand.

### BACKGROUND OF THE INVENTION

1. Technical Field

The invention relates generally to supply and demand planning, and more particularly, to provide accuracy of supply and demand planning by omitting an atypical order item.

2. Background Art

Competitive commercial enterprises require accurate demand forecasting to determine the need for particular units for completing sellable items, e.g., products and/or services. One challenge for achieving accurate demand forecasting is addressing inflated and/or understated unit forecasts based on atypical order items, e.g., an order item requiring a much larger or much smaller number of units for completion. Typically, average demand for a unit for a period of time is calculated based on aggregated usage, i.e., units used in all order items for all sellable items are summed up within a period (e.g., weekly, monthly, etc.). For example, assume that 2 orders contain 50 and 150 units, respectively, in one given week for one sellable item. This consumption results in an average week's demand of 100 units. As a result, each order item's unique impact is lost. The average demand is then used to calculate a unit attach rate for a period of time, which is an average of how many units are used per a number of sellable items. For example, 4% of sellable items may include a unit. Based on that information, a commercial enterprise may forward the number of sellable items ordered by customers of the commercial enterprise and the unit attach rate to a supplier of the unit, and the supplier obtains a forecast of how many units will be required. The supplier may then reserve capacity for the commercial enterprise.

An atypical order item can inaccurately skew demand forecasts for units necessary to complete sellable items. For example, assume an atypical order item requiring 1,000 units in a month's timeframe is received, and that order item is considered during calculation of the above-described average demand. In that case, the average demand would be much higher than 100 units per month. If this inaccurate demand forecast is used, it can result in inventory overages or a backlog. In addition, it may lead to a supplier being inaccurately informed of requirements for a commercial enterprise.

One approach to addressing this situation is to take the atypical order item out of the demand forecasting system so it does not corrupt an average demand for a particular unit. Under this approach, the 1,000 unit order item would be removed so it would not corrupt the 100 units per month average demand. Although this approach prevents corruption of the average demand in such a way that it would overstate requirements, it also prevents forwarding of an order item to suppliers to cover the atypical order item because the order item is removed. As a consequence, the approach oftentimes results in units not being order itemed, thus creating a backlog. In another approach, some systems may use smoothing algorithms to reduce the impact of an atypical order item. However, these approaches introduce inaccuracies and may also result in backlogs or oversupply of units.

In view of the foregoing, there is a need in the art for a solution that allows for improved accuracy in supply and demand planning.

### SUMMARY OF THE INVENTION

Method, system and program product for providing supply and demand planning by omitting an atypical order item is disclosed. In one embodiment, the invention includes a method of identifying an atypical order item, and omitting the atypical order item from at least one of the following: a forecast demand and an order item demand.

A first aspect of the invention provides a method of providing supply and demand planning for a unit, the method comprising the steps of: identifying an atypical order item; and omitting the atypical order item from at least one of the following: a forecast demand and an order item demand.

A second aspect of the invention provides a system for providing supply and demand planning for a unit, the system comprising: an analyzer unit for analyzing order items to identify an atypical order item; and an omitter unit for causing the atypical order item to be omitted from at least one of the following: a forecast demand and an order item demand.

A third aspect of the invention provides a program product stored on a computer-readable medium, which when executed, provides supply and demand planning for a unit, the program product comprising: program code for identifying an atypical order item; and program code for omitting the atypical order item from at least one of the following: a forecast demand and an order item demand.

A fourth aspect of the invention provides a computer-readable medium that includes computer program code to enable a computer infrastructure to provide supply and demand planning for a unit, the computer-readable medium comprising computer program code for performing the method steps of the invention.

An fifth aspect of the invention provides a business method for providing supply and demand planning for a unit, the business method comprising managing a computer infrastructure that performs each of the steps of the invention; and receiving payment based on the managing step.

A sixth aspect of the invention provides a method of providing a service including supply and demand planning for a unit, the method comprising: obtaining a computer infrastructure; and for each of the method steps of the invention, deploying a unit for performing the step to the computer infrastructure.

The illustrative aspects of the present invention are designed to solve the problems herein described and other problems not described that are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a block diagram of a planning system according to one embodiment of the invention.

FIG. 2 shows a flow diagram of one embodiment of an operational methodology of the system of FIG. 1.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As used herein, the following terms shall have the following meanings:

“Order item” is any identification of an order or request for provision of a sellable item. An order item may include an identification by an actual order (i.e., a request for provision of a sellable item), or an identification by a particular customer, or an identification by a planning item (i.e., a sellable item providers internal grouping).

“Sellable item” means any product and/or service that can be sold, e.g., a computer, an automobile, consulting service, etc.

“Unit” means any lower level component of a sellable item, e.g., for a computer, a hard disk drive, a power unit, a video card, a certain memory, etc.

“Unit attach rate” means number of units used per a number of sellable items. For example, 500 cars out of 3500 vehicles sold by an automobile manufacturer may include an AM-FM stereo without a CD player, resulting in an attach rate of 14.3%. Similarly, 2000 cars out of 3500 vehicles may include an AM-FM stereo with a CD player, resulting an attach rate of 57.1%.

“Total forecast for average unit demand” is a forecast of an average number of units required for a particular duration, e.g., a week. For example, 100 units per week.

“Order item detail” includes details of an individual order item of a sellable item including, for example, order number, customer number, sellable item model number, requested ship date, unit identifier and number of units required to fulfill the order.

“Shipment history” is information regarding order items that include a unit and have already been fulfilled.

“Order backlog” are current unfulfilled order items that are creating a demand, or backlog, for a unit.

“Average unit demand” is the average of how many units are used per sellable item.

“Forecast demand” is a predicted number of units required for future order items.

“Order item demand” is a number of units required to fulfill current (i.e., on-the-books) order items.

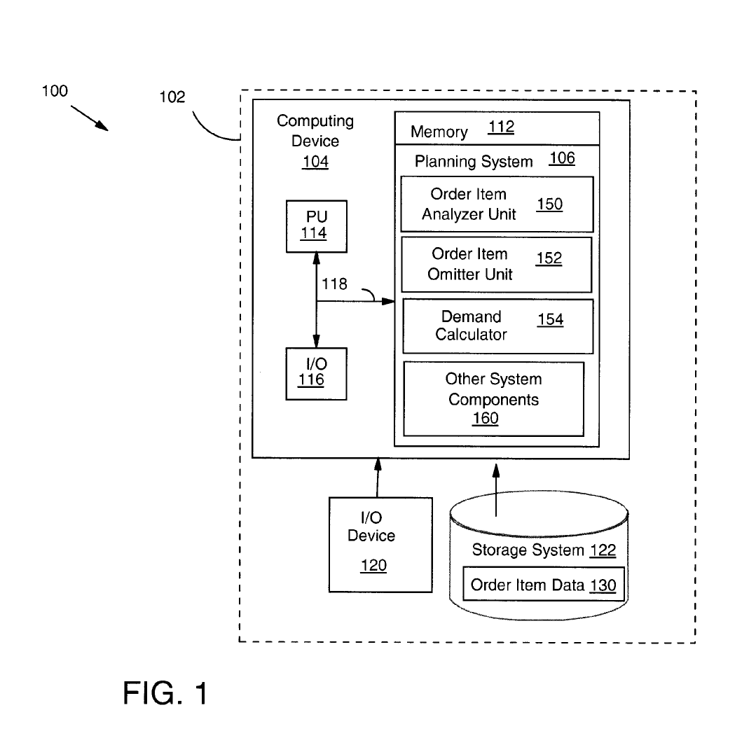

Turning to the drawings, FIG. 1 shows an illustrative environment 100 for providing supply and demand planning for a unit. To this extent, environment 100 includes a computer infrastructure 102 that can perform the various process steps described herein for increasing power stability in an IC. In particular, computer infrastructure 102 is shown including a computing device 104 that comprises a planning system 106, which enables computing device 104 to provide supply and demand planning for a unit by performing the process steps of the invention.

Computing device 104 is shown including a memory 112, a processor 114, an input/output (I/O) interface 116, and a bus 118. Further, computing device 104 is shown in communication with an external I/O device/resource 120 and a storage system 122. As is known in the art, in general, processor 114 executes computer program code, such as planning system 106, that is stored in memory 112 and/or storage system 122. While executing computer program code, processor 114 can read and/or write order item data 130, e.g., order item details, shipment history, etc., to/from memory 112, storage system 122, and/or I/O interface 116. Bus 118 provides a communications link between each of the components in computing device 104. I/O device 118 can comprise any device that enables a user to interact with computing device 104 or any device that enables computing device 104 to communicate with one or more other computing devices.

In any event, computing device 104 can comprise any general purpose computing article of manufacture capable of executing computer program code installed by a user (e.g., a personal computer, server, handheld device, etc.). However, it is understood that computing device 104 and planning system 106 are only representative of various possible equivalent computing devices that may perform the various process steps of the invention. To this extent, in other embodiments, computing device 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 102 is only illustrative of various types of computer infrastructures for implementing the invention. For example, in one embodiment, computer infrastructure 102 comprises two or more computing devices (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computing devices may utilize any combination of various types of transmission techniques.

As previously mentioned and discussed further below, planning system 106 enables computing infrastructure 102 to provide supply and demand planning for a unit. To this extent, planning system 106 is shown including an order item analyzer unit 150, an order item omitter unit 152, a demand calculator 154 and other system components 160. Other system components 160 may include any other functions typically provided as part of a conventional supply and demand planning system such as ship netting, demand skewing, offsets, etc. Operation of each of these systems is discussed further below. However, it is understood that some of the various systems shown in FIG. 1 can be implemented independently, combined, and/or stored in memory for one or more separate computing devices that are included in computer infrastructure 102. Further, it is understood that some of the systems and/or functionality may not be implemented, or additional systems and/or functionality may be included as part of environment 100.

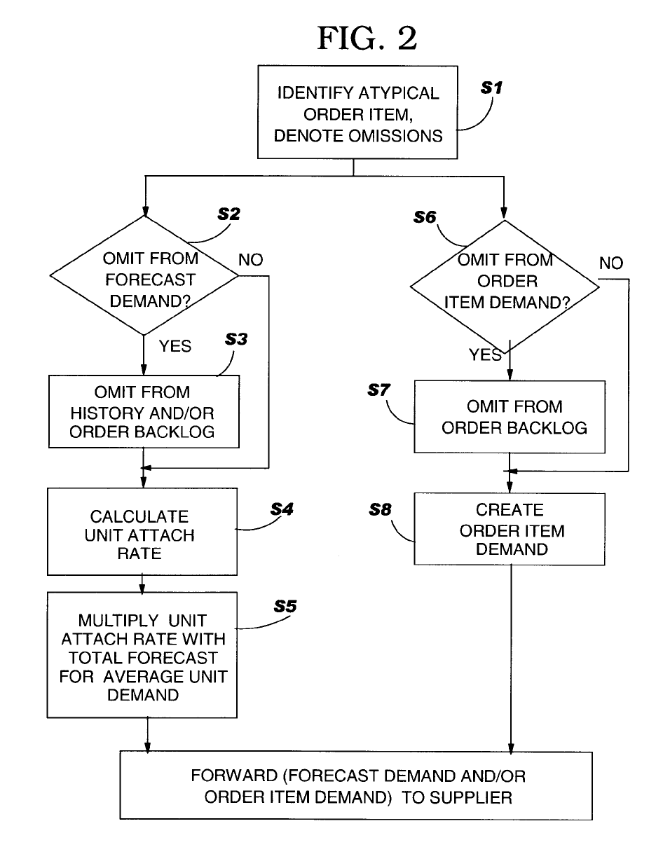

Turning to FIG. 2, one embodiment of an operational methodology of the above-described planning system 106 will now be described.

In a first step S1, order item analyzer unit 150 analyzes order items to identify an atypical order item. An “atypical order item” can be any order item that may distort either a demand forecast for a unit or an order item demand for a unit. For example, in an automotive manufacturer, an unusually large order item for cars with AM only radios, which are very infrequently requested devices, may inappropriately impact a demand forecast for AM radios. As a result, surplus AM radios may have to be inventoried at the automotive manufacturer and/or its suppliers. In one embodiment, a user may manually identify atypical order items based on knowledge of orders and/or shipment history. In an alternative embodiment, order item analyzer unit 150 may understand the specifics of order items to determine if an atypical order item was out of an acceptable range, e.g., using holistics, empirical data, artificial intelligence, etc. In one embodiment of this type analysis, an atypical order item may be automatically identified based on the order item meeting a difference threshold compared to a part of a shipment history. For example, if shipment history indicates an average unit demand is 50 and the atypical order item requires 500 units, a difference threshold set to identify a difference of ±10 units would be met by the order item and it would be identified as an atypical order item. In another example, unit attach rate trend reports are used to leverage user product knowledge. In particular, order item analyzer unit 150 can compare unit attach rates from shipment history to a unit attach rate including atypical order item(s). Order item analyzer unit 150 can then identify any order items that are out of the norm based on the unit attach rate exceeding a difference threshold, e.g., more than ±10% difference from shipment history. As an example, assume for a given week, there is a demand for 100 cars, of which 50 required AM radios and 25 required an AM-FM-CD radio and 25 did not require any radio. This results in a unit attach rate of 50% for AM radios and 25% for the AM-FM-CD radios and 25% for no radio. Order item analyzer unit 150 notices the large unit attach rate because it exceeds a difference threshold, e.g., for the AM radio, and investigates what drove this demand. Investigation may reveal, for example, a special one-time order item for 50 cars with this configuration, which is atypical. Since this is an atypical order item, order item analyzer unit 150 may identify this order item for 50 cars with AM radios as an un-wanted anomaly that would impact forecast demand and/or order item demand, and therefore would identify the order item as atypical. An order item may also be initially established as an atypical order item by order item analyzer unit 150 because it is placed to satisfy a highly configured sellable item, making it atypical. It should be recognized that any of a variety of different techniques may be used to identify an atypical order item.

In addition, at step S1, order item analyzer unit 150 may also determine how an atypical order item is to be omitted. That is, order item analyzer unit 150 may denote an identified atypical order item as one that should be omitted from forecast demand and/or order item demand. An atypical order may be omitted from forecast demand, for example, because it is likely to skew the forecast demand (and unit attach rate). For example, based on the above-described example, order item analyzer unit 150 may indicate that the 50 AM radio atypical order is to be omitted from forecast demand. The resultant calculated unit attach rate at step S4, described below, would return an average ratio of 50% for the AM-FM-CD radio and 50% for no radio based on the aggregated orders of 50 cars after omitting the atypical order item for 50 cars with AM radios. Accordingly, the atypical order item would not impact forecast demand.

Now, assume that the 50 AM radios were required for two order items, one with 20 and the other with 30. Order item analyzer unit 150 may indicate to omit each order item from the forecast demand. In addition, or alternatively, order item analyzer unit 150 may indicate that the atypical order item should be omitted from order item demand. An atypical order may be omitted from order item demand for a number of reasons. For example, the atypical order item may be in a situation where it is being reconsidered by a customer, or the order item may have been canceled. As a result, placing the atypical order item into the order item demand may negatively impact the order item demand, i.e., negatively impact the supply of units such as ordering an incorrect number of units or ordering an incorrect number of units that are alternatives to the particular units ordered. Relative to the example order items described above, the one for 30 cars with AM radios may not be complete (confirmed) and therefore should be indicated for omission from the order item demand. In contrast, the other order item for 20 AM radios may be complete and confirmed to be part of the order item demand.

Next, as shown in steps S2-S5 and in steps S6-S8, order item omitter unit 152 may cause an atypical order item to be omitted from a forecast demand and/or an order item demand. In one embodiment, a user knowledgeable about typical orders may manually indicate how the order item is to be omitted. In another embodiment, as described in above, order item omitter unit 152 determines in what way an atypical order item is omitted based on an indication provided by order item analyzer unit 150. That is, as described above, order item analyzer unit 150 may denote an identified atypical order item as one that should be omitted from forecast demand and/or order item demand.

In step S2, order item omitter unit 152 determines whether the atypical order item is to be omitted from a forecast demand, e.g., whether order item analyzer unit 150 denoted the atypical order item as one that should be omitted from the forecast demand. If NO at step S2, then processing proceeds to step S4-S5, as will be described below. If YES at step S2, processing proceeds to step S3, at which order item omitter unit 152 omits the atypical order item(s) from the shipment history and/or the order backlog. The type of omission relative to shipment history and/or order backlog is based on where the atypical order item is, i.e., it is removed from wherever it is of record.

In step S4-S5, a forecast demand is calculated by demand calculator 154. In particular, in step S4, demand calculator 154 calculates a unit attach rate for an average unit demand. As described above, a unit attach rate is the number of units used per a number of sellable items. For example, 500 cars out of 3500 vehicles sold by an automobile manufacturer may include an AM-FM stereo without a CD player, resulting in an attach rate of 14.3%. Similarly, 2000 cars out of 3500 vehicles may include an AM-FM stereo with a CD player, resulting in an attach rate of 57.1%. In step S5, demand calculator 154 calculates the forecast demand by multiplying the unit attach rate by the total forecast for average unit demand. The forecast demand may then be forwarded to a supplier. The above-described steps will improve the accuracy of the unit demand to the suppliers allowing for better capacity planning and reduces the churn in demand.

Returning to step S6, order item omitter unit 152 determines whether the atypical order item is to be omitted from an order item demand, e.g., whether order item analyzer unit 150 denoted the atypical order item as one that should be omitted from the order item demand. If NO at step S6, processing proceeds to step S8, which is described below. If YES at step S6, processing proceeds to step S7, at which order item omitter unit 152 omits the atypical order from the order backlog.

In step S8, demand calculator 154 calculates an order item demand. In one embodiment, demand calculator 154 will start with the aggregated order item demand quantities per period at both the finished good and the unit levels, and will remove any identified atypical order items that were indicated for omission by order item analyzer unit 150. The calculation will result in the final order item demand that is then forwarded to the supplier.

The above-described planning system 106 provides provided supply and demand planning by reducing inventory, allowing demand planners to better control forecast demand and provides a more accurate forecast demand. In addition, system 106 provides improved accuracy for supplier capacity reservation by better controlling order item demand.

It is understood that the order item of the above-described steps is only illustrative. To this extent, one or more steps can be performed in parallel, in a different order item, at a remote time, etc. Further, one or more of the steps may not be performed in various embodiments of the invention.

While shown and described herein as a method and system for providing supply and demand planning, it is understood that the invention further provides various alternative embodiments. For example, in one embodiment, the invention provides a computer-readable medium that includes computer program code to enable a computer infrastructure to provide supply and demand planning. To this extent, the computer-readable medium includes program code, such as planning system 106 (FIG. 1), which implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 112 (FIG. 1) and/or storage system 122 (FIG. 1) (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider, such as an Internet Service Provider, could offer to provide supply and demand planning as described above. In this case, the service provider can manage (e.g., create, maintain, support, etc.) a computer infrastructure, such as computer infrastructure 102 (FIG. 1), that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of providing a service for providing supply and demand planning. In this case, a computer infrastructure, such as computer infrastructure 102 (FIG. 1), can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computing device, such as computing device 104 (FIG. 1), from a computer-readable medium; (2) adding one or more computing devices to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method of providing supply and demand planning for a unit, the method comprising the steps of:
identifying an atypical order item; and
omitting the atypical order item from at least one of the following: a forecast demand and an order item demand.

2. The method of claim 1, wherein the identifying step is automatic based on an order item meeting a difference threshold compared to a part of a shipment history.

3. The method of claim 1, wherein the identifying step further includes denoting how an atypical order item is to be omitted.

4. The method of claim 1, wherein the order item includes one of: an individual order item, at least one order item by a particular customer and a planning item.

5. The method of claim 1, wherein in response to the atypical order item being omitted from the forecast demand, the omitting step further includes omitting the atypical order item from at least one of the following: a shipment history and an order backlog.

6. The method of claim 5, further comprising the step of calculating the forecast demand by:
calculating a unit attach rate for an average unit demand; and
multiplying the unit attach rate by a forecast for the average unit demand.

7. The method of claim 1, wherein in response to the atypical order item being omitted from the order item demand, the omitting step further includes omitting the atypical order item from the order backlog.

8. A method of providing a service including supply and demand planning for a unit, the method comprising:
obtaining a computer infrastructure; and
for each of the steps of claim 1, deploying a unit for performing the step to the computer infrastructure.

9. A computer-readable medium for enabling a computer infrastructure to supply and demand planning for a unit, the computer-readable medium comprising computer program code for performing the method steps of claim 1.

10. A system for providing supply and demand planning for a unit, the system comprising:
an analyzer unit for analyzing order items to identify an atypical order item; and
an omitter unit for causing the atypical order item to be omitted from at least one of the following: a forecast demand and an order item demand.

11. The system of claim 10, wherein the omitter unit identifies an atypical order item based on an order item meeting a difference threshold compared to a part of a shipment history.

12. The system of claim 10, wherein the order item includes one of: an individual order item, at least one order item by a particular customer and a planning item.

13. The system of claim 10, wherein in response to the atypical order item being omitted from the forecast demand, the omitting unit further omits the atypical order item from at least one of the following: a shipment history and an order backlog.

14. The system of claim 13, further comprising a demand calculator, wherein the demand calculator calculates the forecast demand by:
calculating a unit attach rate for an average unit demand; and
multiplying the unit attach rate by a forecast for the average unit demand.

15. The system of claim 10, wherein in response to the atypical order item being omitted from the order item demand, the omitter unit further omits the atypical order item from the order backlog.

16. A program product stored on a computer-readable medium, which when executed, provides supply and demand planning for a unit, the program product comprising:
program code for identifying an atypical order item; and
program code for omitting the atypical order item from at least one of the following: a forecast demand and an order item demand.

17. The program product of claim 16, wherein the order item includes one of: an individual order item, at least one order item by a particular customer and a planning item.

18. The program product of claim 16, wherein in response to the atypical order item being omitted from the forecast demand, the omitting code further omits the atypical order item from at least one of the following: a shipment history and an order backlog.

19. The program product of claim 18, further comprising program code for calculating the forecast demand by:
calculating a unit attach rate for an average unit demand; and
multiplying the unit attach rate by a forecast for the average unit demand.

20. The program product of claim 16, wherein in response to the atypical order item being omitted from the order item demand, the omitting code further omits the atypical order item from the order backlog.
